(19) United States
(12) Patent Application Publication
(10) Pub. No.: US 2015/0295426 A1
(43) Pub. Date: Oct. 15, 2015

(54) BATTERY AND ELECTRONIC DEVICE

(71) Applicant: Kabushiki Kaisha Toshiba, Tokyo (JP)

(72) Inventors: Hideki Hirosawa, Fujioka Gumma (JP); Yutaka Horie, Mitaka (JP)

(21) Appl. No.: 14/537,726

(22) Filed: Nov. 10, 2014

Related U.S. Application Data
(60) Provisional application No. 61/978,472, filed on Apr. 11, 2014.

(51) Int. Cl. H02J 7/00; H02J 7/34; G06F 1/26

(52) U.S. Cl. CPC H02J 7/0016; G06F 1/263; H02J 7/0024; H02J 7/345

(57) ABSTRACT

According to one embodiment, a battery stack includes a plurality of battery cells connected in series. A first battery terminal is electrically connected to a positive electrode of a topmost battery cell in the battery stack. Through the first battery terminal, first power is supplied from the battery stack to a host. A first switch selects a highest-voltage battery cell from the plurality of battery cells. A feed circuit supplies second power to a controller in a battery or a first device in the host by using a charge of the selected battery cell.

### CROSS-REFERENCE TO RELATED APPLICATIONS

This application claims the benefit of U.S. Provisional Application No. 61/978,472, filed Apr. 11, 2014, the entire contents of which are incorporated herein by reference.

### FIELD

Embodiments described herein relate generally to a battery and an electronic device powered by the battery.

### BACKGROUND

In general, portable electronic devices such as personal computers are configured to be powered by a battery. In many portable electronic devices, the output voltage of the battery is converted into the desired voltage by a voltage regulator such as a linear regulator.

Therefore, in the case where the power from a battery is used for driving a low-voltage device, sometimes a large power loss is produced in a voltage regulator. Thus, a new function for more efficiently using the power from the battery is required.

Normally, the greater the number of charge-discharge cycles of a battery is, the greater the difference in degree of deterioration of the battery cells in the battery is. For this reason, it is useful to perform cell balancing to balance the voltage and capacitance of all battery cells in a battery.

However, in the conventional cell balancing technique, the charge of battery cells is uselessly discharged.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram illustrating the structure of a power-supply system including a battery according to one embodiment.

FIG. 2 is an exemplary diagram illustrating an example of the structure of the battery of the embodiment.

FIG. 3 is an exemplary diagram illustrating the operation of charging a first capacitor by transferring the charge of the highest-voltage battery cell in a battery stack of the battery of the embodiment to the first capacitor.

FIG. 4 is an exemplary diagram illustrating the operation of transferring charge from the first capacitor of FIG. 3 to a second capacitor.

FIG. 5 is an exemplary diagram illustrating the operation of recharging the first capacitor when the voltage of the second capacitor of FIG. 4 is decreased.

FIG. 6 is an exemplary diagram illustrating an example of the structure of a voltage regulator in the battery of the embodiment.

FIG. 7 is an exemplary flowchart illustrating steps of an operation executed by the battery of the embodiment.

FIG. 8 is an exemplary diagram illustrating another example of the structure of the battery of the embodiment.

FIG. 9 is an exemplary perspective view illustrating the external appearance of an electronic device comprising the battery of the embodiment.

FIG. 10 is an exemplary block diagram illustrating an example of the system configuration of the electronic device of FIG. 9.

FIG. 11 is an exemplary diagram illustrating a power source supply route to a real-time clock (RTC) in the electronic device of FIG. 9.

FIG. 12 is an exemplary diagram illustrating another example of the structure of the battery stack in the battery of the embodiment.

FIG. 13 is an exemplary diagram illustrating another example of the structure of the battery stack in the battery of the embodiment.

### DETAILED DESCRIPTION

Various embodiments will be described hereinafter with reference to the accompanying drawings.

In general, according to one embodiment, a battery includes a battery stack, a controller, a first battery terminal, a first switch and a feed circuit. The battery stack includes a plurality of battery cells connected in series. The controller manages a state of the battery stack. The first battery terminal is electrically connected to a positive electrode of a topmost battery cell in the battery stack. Through the first battery terminal, first power is supplied from the battery stack to a host. The first switch selects a highest-voltage battery cell from the plurality of battery cells. The feed circuit supplies second power to a first device in the host through a second battery terminal of the battery or supplies the second power to the controller in the battery, by using a charge of the selected battery cell.

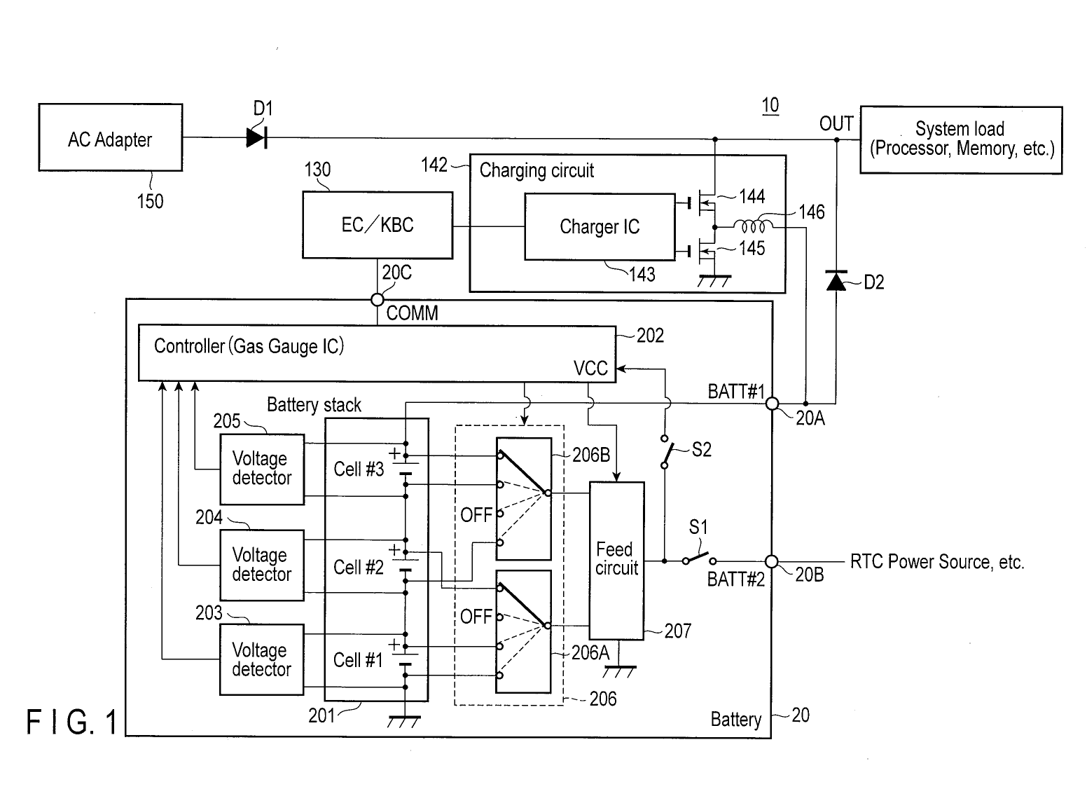

FIG. 1 illustrates an example of the structure of a power-supply system including a battery 20 according to one embodiment. This power-supply system is configured to supply operating power to each component in an electronic device 10. The battery 20 may be a built-in battery housed in the electronic device 10. Alternatively, the battery 20 may be a removable battery which is removably attached to the electronic device 10. The term “built-in battery” is different from the above-described “removable battery” which can be easily removed by the user from the electronic device 10. The term “built-in battery” refers to a battery which, like various components in the electronic device 10, cannot be easily removed from the electronic device 10. The work for removing the built-in battery from the electronic device 10 is normally associated with decomposition of the electronic device 10. For this reason, the work for removing the built-in battery from the electronic device 10 is conducted in a support center. The built-in battery does not require a mechanical structure for removably attaching the battery to the electronic device 10. Thus, the built-in battery is suitable for the reduction in size and thickness of the electronic device 10.

This power-supply system supplies operating power to each component (system load) in the electronic device 10, using the power from an external power source such as an AC adapter 150 or the power from the battery 20. Thus, each component is powered by an external power source or the battery 20. Examples of the system load in the electronic device 10 are a processor, a memory, a display panel and various types of I/O devices, etc., in the electronic device.

The AC adapter 150 functions as an external power source (AC-DC converter) configured to convert alternating-current power into direct-current power. The output of the AC adapter 150 is connected to the power source output terminal OUT of the power-supply system via diode D1. The power source output terminal OUT is connected to each component through a system power source supply line for supplying power to the system (each component).

Further, a first battery terminal 20A of the battery 20 may be connected to the power source output terminal OUT of the power-supply system via diode D2. Instead of diode D2, a switch (for example, an FET switch) may be used. In this case, the first battery terminal 20A of the battery 20 is connected to the power source output terminal OUT of the power-supply system via the FET switch. For example, a voltage regulator such as a linear voltage regulator and a switching DC-DC converter may be provided between the power source output terminal OUT and the system load.

The output voltage of the AC adapter 150 may be set to be higher than the output voltage of the battery 20 (the output voltage of the first battery terminal 20A). In this case, when the AC adapter 150 is connected to the electronic device 10, the voltage of the power source output terminal OUT is higher than the output voltage of the battery 20. Thus, the battery 20 is not discharged. In other words, when the AC adapter 150 is connected to the electronic device 10, as the power source for supplying power to the system load, the AC adapter 150 is used in preference to the battery 20.

On the other hand, when the AC adapter 150 is not connected to the electronic device 10, the battery 20 can be discharged. The battery 20 is utilized as the power source for supplying power to the system load.

The power-supply system further comprises a charging circuit 142. The charging circuit 142 charges the battery 20, using the power from the AC adapter 150 under the control of an embedded controller/keyboard controller IC (EC/KBC) 130 in the electronic device 10.

The charging circuit 142 may comprise a charger IC 143, a high-side FET 144, a low-side FET 145 and an inductor 146. The charger IC 143 may control and switch the high-side FET 144 and the low-side FET 145 to generate charging current for charging the battery 20.

The battery 20 may comprise a battery stack 201, a controller 202, voltage detectors 203, 204 and 205, a first switch 206 and a feed circuit 207.

The battery stack 201 is, for example, a multi-cell battery stack. The battery stack 201 may comprise a plurality of battery cells connected in series. FIG. 1 illustrates an example of the stack structure in which three battery cells #1, #2 and #3 are connected in series.

Battery cells #1, #2 and #3 may be, for example, Li-ion cells. The positive electrode of the topmost battery cell (top cell) of the battery stack 201 may be electrically connected to the first battery terminal 20A of the battery 20. In the example of FIG. 1, battery cell #3 is the topmost battery cell. The positive electrode of battery cell #3 is electrically connected to the first battery terminal 20A of the battery 20.

The first battery terminal 20A is a terminal for discharging and charging the battery stack 201. The first battery power (BATT#1) is supplied from the battery stack 201 to the electronic device 10 via the first battery terminal 20A. Between the positive electrode of the topmost battery cell (battery cell #3) and the first battery terminal 20A, a protection circuit, etc., may be inserted.

The controller 202 may function as a gas gauge IC configured to manage the state of the battery stack 201 such as the remaining capacity, the number of charge-discharge cycles and the temperature. The controller 202 may comprise a serial interface for communicating with the host (electronic device 10). The serial interface may provide the EC/KBC 130 of the host (electronic device 10) with information COMM related to the state of the battery stack 201 via a communication terminal 20C of the battery 20.

The electronic device 10 may comprise a device (for example, a real-time clock (RTC)) which is required to operate during the power-off state of the electronic device 10. In the conventional system, a real-time clock (RTC) comprises an RTC battery which is a battery dedicated to the real-time clock (RTC). The RTC battery may be, for example, a button battery. While the electronic device 10 is in the power-off state, the real-time clock (RTC) is powered by the RTC battery.

In this embodiment, the battery 20 may be a built-in battery as described above. In this case, the user normally cannot remove the battery 20 from the electronic device 10. The battery 20 can be used as the power source for supplying power to the real-time clock (RTC) during the power-off state of the electronic device 10. This structure enables the elimination of the RTC battery for the purpose of cost reduction.

However, the output voltage of the battery stack 201 is normally set to be comparatively high in order to supply sufficient power to the system load. Therefore, if the electronic device employs the structure of supplying the power source voltage which is obtained by stepping-down the voltage from the first battery terminal 20A by means of a voltage regulator to the real-time clock (RTC), a large power loss may be produced in the voltage regulator. Through this power loss, the power discharged from the battery stack 201 is wasted.

In this embodiment, the battery 20 is configured to supply the second battery power (BATT#2), which is obtained by using the charge of one arbitrary battery cell in the battery stack 201, to a low-voltage device in the electronic device 10 such as the real-time clock (RTC).

The controller (gas gauge IC) 202 in the battery 20 is also a low-voltage device which is required to operate even while the electronic device 10 is in the power-off state. Therefore, the second battery power (BATT#2) may be supplied to the controller 202 in the battery 20. In this manner, the power loss can be reduced compared to the case where the power source voltage which is obtained by stepping-down the voltage of the battery stack 201 by means of a voltage regulator is supplied to the controller 202.

The second battery power (BATT#2) may not be supplied to the real-time clock (RTC) and may be supplied to only the controller 202. In this case, the battery 20 does not necessarily have to be a built-in battery. The battery 20 may be a removable battery which is removably attached to the electronic device 10.

In this embodiment, the highest-voltage battery cell in the battery stack 201 is selected. The charge of the selected battery cell is used for generating the second battery power (BATT#2). If the voltage of the selected battery cell is decreased by degradation of the battery cell, or in short, if the highest-voltage battery cell is changed to another battery cell, this battery cell is newly selected. The charge of the newly-selected battery cell is used for generating the second battery power (BATT#2).

Thus, in this embodiment, a specific battery cell is not used for generating the second battery power (BATT#2). Instead, the highest-voltage battery cell in the battery stack 201 is selected. In detail, the highest-voltage battery cell is selected from battery cells each having a voltage higher than a reference voltage. The charge of the selected battery cell is used for generating the second battery power (BATT#2).

Thus, the battery cell to be used for generating the second battery power can be switched among a plurality of battery cells connected in series. Therefore, it is possible to elongate the time in which power can be continuously supplied to a low-voltage device such as the real-time clock (RTC) by means of the battery 20.

Moreover, this structure which avoids using a deteriorated battery cell (a battery cell whose voltage is decreased to a reference voltage or lower) and uses the highest-voltage battery cell functions as a cell balancing operation for balancing the capacitance and voltage of the battery cells in the battery stack 201.

In the conventional simple cell balancing, the power of the highest-voltage battery cell is uselessly consumed by the resistance connected to the battery cell and is converted into heat. On the other hand, in this embodiment, the charge of the highest-voltage battery cell is supplied as operating power to a low-voltage device such as the real-time clock (RTC). Thus, cell balancing can be efficiently performed.

In the case where the discharge current from the highest-voltage battery cell is too small for cell balancing by merely supplying power to the real-time clock (RTC), the second battery power (BATT#2) may be supplied to, in addition to the real-time clock (RTC), for example, another low-voltage device in the electronic device 10.

The voltage detectors 203, 204 and 205, the first switch 206 and the feed circuit 207 are used for the above-described generation of the second battery power (BATT#2).

The voltage detector 203 may detect the voltage (cell voltage) of battery cell #1 by measuring the voltage across battery cell #1. The voltage detector 204 may detect the voltage of battery cell #2 by measuring the voltage across battery cell #2. The voltage detector 205 may detect the voltage of battery cell #3 by measuring the voltage across battery cell #3. The detected cell voltage of battery cells #1, #2 and #3 may be sent to the controller 202.

The first switch 206 may select the highest-voltage battery cell from the series battery cells in the battery stack 201, under the control of the controller 202. The first switch 206 may be realized by two interlock switches 206A and 206B. Switch 206A may select the negative electrode of the highest-voltage battery cell. Switch 206A may connect the negative electrode of the selected battery cell and the feed circuit 207. Switch 206B may select the positive electrode of the highest-voltage battery cell. Switch 206B may connect the positive electrode of the selected battery cell and the feed circuit 207.

The feed circuit 207 may supply the second battery power (BATT#2) to the controller 202 or a low-voltage device (for example, the real-time clock (RTC)) in the electronic device 10 by means of the charge of the selected battery cell.

The battery 20 may comprise a second battery terminal 20B. The second battery power (BATT#2) may be supplied to a low-voltage device (for example, the real-time clock (RTC)) in the electronic device 10 via the second battery terminal 20B. Switch S1 may be inserted between the output of the feed circuit 207 and the second battery terminal 20B. Similarly, switch S2 may be inserted between the output of the feed circuit 207 and the power source terminal (VCC) of the controller 202.

Switches S1 and S2 may be turned on or off by the controller 202. By this operation, the second battery power (BATT#2) can be supplied to both the controller 202 and a low-voltage device in the electronic device 10, or one of the controller 202 and a low-voltage device in the electronic device 10.

In the case where the second battery power (BATT#2) is supplied to a low-voltage device in the electronic device 10, the feed circuit 207 may transfer the charge of the selected battery cell to the low-voltage device in a state in which the negative electrode of the selected battery cell is isolated from the ground terminal of the low-voltage device. In this case, the charge from the selected battery cell is transferred to the low-voltage device in a state in which the negative electrode of the selected battery cell is floating. This structure allows safe transfer of the charge of the selected battery cell to the low-voltage device without short-circuiting the battery stack 201, or in other words, without causing the connection between the negative electrode of battery cell #2 or the negative electrode of battery cell #3 and the ground if any battery cell in the battery stack 201 is selected.

The ground terminal of the battery 20 may be configured to be electrically connected to the ground terminal in the electronic device 10. In this case, the ground terminal of a low-voltage device and the ground terminal in the battery 20 are the common ground. The feed circuit 207 may transfer the charge of the selected battery cell to the low-voltage device in a state in which the negative electrode of the selected battery cell is isolated from the common ground.

Similarly, in the case where the second battery power (BATT#2) is supplied to the controller 202, the feed circuit 207 may transfer the charge of the selected battery cell to the controller 202 in a state in which the negative electrode of the selected battery cell is isolated from the ground terminal of the controller 202.

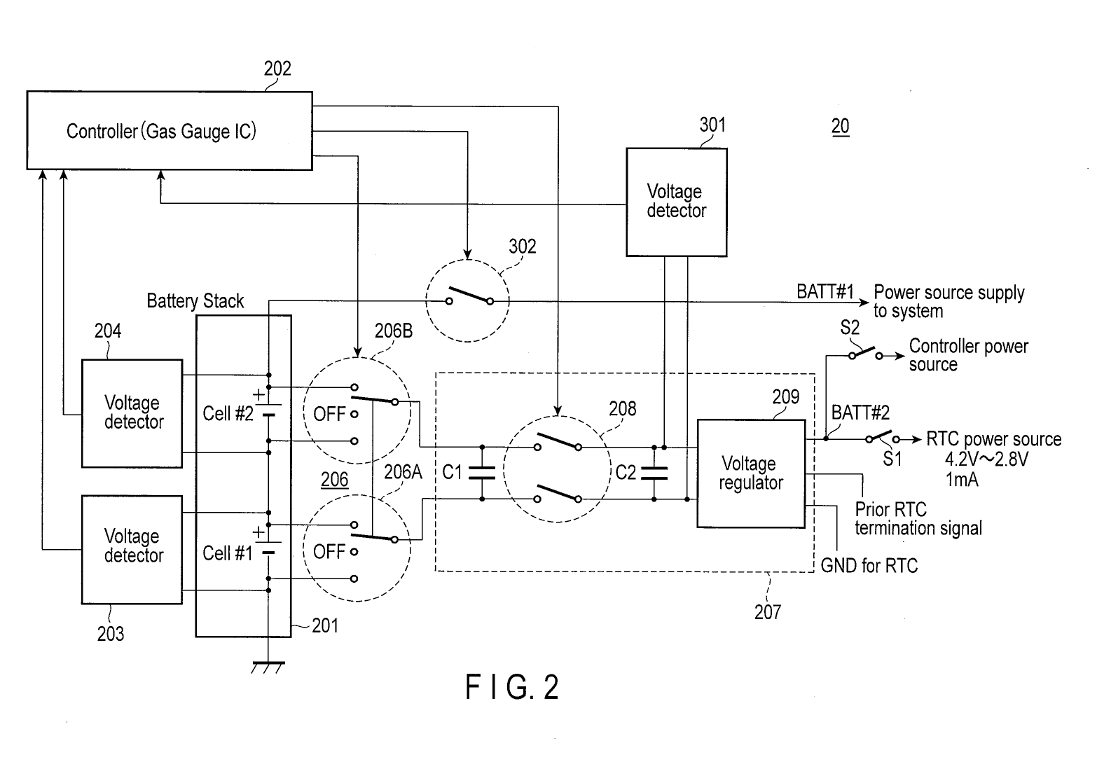

FIG. 2 illustrates an example of the structure of the battery 20.

For the purpose of simplification, FIG. 2 presumes a case where the battery stack 201 is composed of two battery cells #1 and #2 connected in series. An over-current protection switch 302 may be connected to the output of the battery stack 201. The feed circuit 207 may comprise a first capacitor C1, a second switch 208, a second capacitor C2 and a voltage regulator 209. As the first capacitor 01, a capacitor having a capacitance greater than that of the second capacitor C2 may be employed.

The first capacitor C1 may be provided in the subsequent stage of the first switch 206 (interlock switches 206A and 206B). The first capacitor C1 can be used as an energy accumulation element for accumulating the charge of the battery cell selected by the first switch 206 (interlock switches 206A and 206B). The second switch 208 may be connected between the first capacitor C1 and the second capacitor C2. The second switch 208 can function as a switch for connecting the first capacitor C1 and the second capacitor C2 or breaking the connection between them. The voltage regulator 209 may generate the above-described second battery power (BATT#2) having the desired voltage by adjusting the voltage of the second capacitor C2. The voltage regulator 209 can function as a circuit for supplying the second battery power (BATT#2) to the controller 202 or a low-voltage device in the host by using the charge of the second capacitor C2.

As the circuit for supplying the second battery power (BATT#2) to the controller 202 or a low-voltage device in the host by using the charge of the second capacitor C2, it is possible to use, instead of the voltage regulator 209, a circuit configured to transfer the charge itself of the second capacitor C2 to the controller 202 or the real-time clock (RTC). A voltage detector 301 may detect the voltage of the second capacitor C2.

By turning on the first switch 206 (interlock switches 206A and 206B) and turning off the second switch 208, the first capacitor C1 is charged with the charge from the selected battery cell. In other words, in a state in which the first capacitor C1 is isolated from the second capacitor C2, the charge from the selected battery cell is transferred to the first capacitor C1.

By turning off the first switch 206 (interlock switches 206A and 206B) and turning on the second switch 208, the second capacitor C2 is charged with the charge from the first capacitor C1. In other words, in a state in which the selected battery cell is isolated from the first capacitor C1, the charge of the first capacitor C1 is transferred to the second capacitor C2.

The charge from the selected battery cell is transferred to the voltage regulator 209 by means of the bucket-brigade system using the switches 206 and 208 and the capacitors C1 and C2. Thus, the charge of the selected battery cell can be safely transferred to a low-voltage device, etc., without short-circuiting the battery stack 201.

Since the power source current required for a low-voltage device is normally approximately 1 mA, the circuit including the switches 206 and 208 and the capacitors C1 and C2 can be realized at low cost. Therefore, it is possible to implement the structure of transferring the charge from the selected battery cell to the voltage regulator 209 by means of the bucket-brigade system using the switches 206 and 208 and the capacitors C1 and C2 in this embodiment at low cost.

When the voltage of the second capacitor C2 is decreased, the second switch 208 is turned off, and the first switch 206 (interlock switches 206A and 206B) is turned on. By this operation, the first capacitor C1 is charged again with the charge from the selected battery cell. Then, the first switch 206 (interlock switches 206A and 206B) is turned off, and the second switch 208 is turned on. In this manner, the second capacitor C2 is charged again.

If the cell voltage of the selected battery cell is decreased to the defined value by the deterioration of the battery cell, or in other words, if the highest-voltage battery cell is changed to another battery cell, this battery cell is newly selected.

When the cell voltages of all battery cells are decreased to the defined value, the supply of the second battery power (BATT#2) to some devices may be controlled so as to be stopped in stages. Now, this specification assumes a case where the second battery power (BATT#2) is supplied to the controller 202, the RTC and another device. When the cell voltage is decreased to the first defined value, firstly, the supply of the second battery power (BATT#2) to the device may be stopped. Next, when the cell voltage is further decreased to the second defined value which is lower than the first defined value, the supply of the second battery power (BATT#2) to the RTC may be stopped. Lastly, when the cell voltage is further decreased to the third defined value which is lower than the second defined value, the supply of the second battery power (BATT#2) to the controller 202 may be stopped. Afterward, the first switch 206 (interlock switches 206A and 206B) may be maintained in the off state.

Before the supply of the second battery power (BATT#2) to a device is stopped, a prior termination signal for notifying that the supply of the second battery power (BATT#2) to the device is stopped may be output. For example, regarding the RTC, before the supply of the second battery power (BATT#2) to the RTC is stopped, a prior termination signal (prior RTC termination signal) for notifying that the supply of the second battery power (BATT#2) to the RTC is stopped may be output. After the prior RTC termination signal is output, the supply of the second battery power (BATT#2) to the RTC may be stopped.

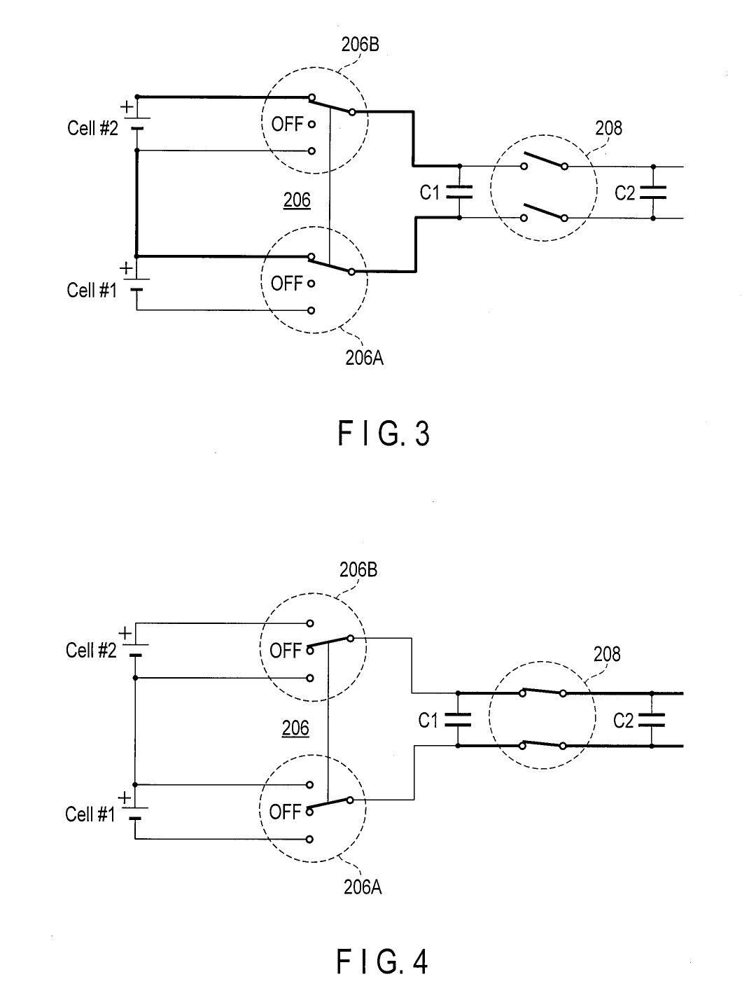

FIG. 3 illustrates the operation of charging the first capacitor C1 by transferring the charge of the selected battery cell to the first capacitor C1.

The controller 202 may determine which battery cell has a higher voltage by comparing the cell voltage of battery cell #1 detected by the voltage detector 203 with the cell voltage of battery cell #2 detected by the voltage detector 204. The battery cell having a higher voltage may be selected by interlock switches 206A and 206B in a state in which the second switch 208 is turned off under the control of the controller 202. For example, when the cell voltage across battery cell #2 is higher than the cell voltage across battery cell #1, as shown in FIG. 3, interlock switch 206A may be switched to be connected to the negative electrode side of battery cell #2, and interlock switch 206B may be switched to be connected to the positive electrode side of battery cell #2. As a result, in a state in which the first capacitor C1 is isolated from the second capacitor C2, the first capacitor C1 is connected to both ends of battery cell #2. The charge from battery cell #2 is transferred to the first capacitor C1 to charge the first capacitor C1.

FIG. 4 illustrates the operation of transferring charge from the first capacitor C1 to the second capacitor C2.

Interlock switches 206A and 206B are turned off under the control of the controller 202. By this operation, the first capacitor C1 is isolated from all of the battery cells. Then, under the control of the controller 202, the second switch 208 is turned on. The charge of the first capacitor C1 is transferred to the second capacitor C2 to charge the second capacitor C2. The second battery power (BATT#2) is generated by using the charge accumulated in the second capacitor C2.

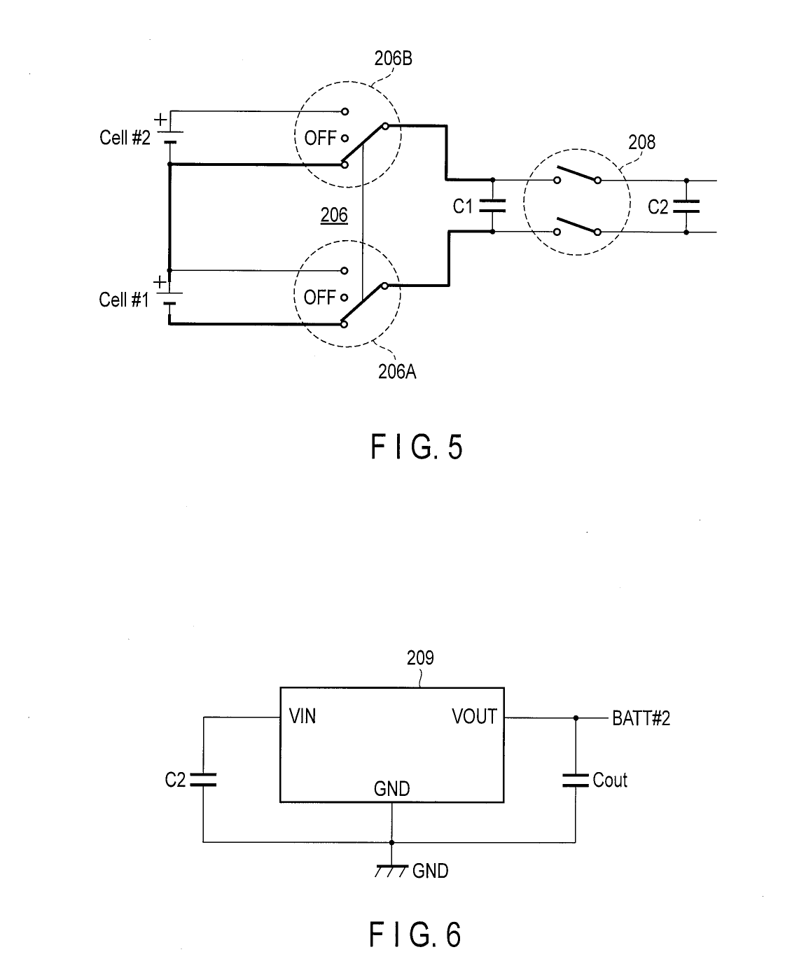

FIG. 5 illustrates the operation of recharging the first capacitor C1 when the voltage of the second capacitor C2 is decreased.

When the voltage of the second capacitor C2 detected by the voltage detector 301 is decreased to a threshold, the second switch 208 is turned off under the control of the controller 202. The battery cell having a higher voltage is selected by interlock switches 206A and 206B. FIG. 5 presumes a case where the cell voltage across battery cell #1 is higher than the cell voltage across battery cell #2.

Interlock switch 206A is switched to be connected to the negative electrode side of battery cell #1. Interlock switch 206B is switched to be connected to the positive electrode side of battery cell #1. As a result, the first capacitor C1 is connected to both ends of battery cell #1 in a state in which the first capacitor C1 is isolated from the second capacitor C2. The charge from battery cell #1 is transferred to the first capacitor C1 to charge the first capacitor C1.

FIG. 6 illustrates an example of the structure of the voltage regulator 209.

FIG. 6 presumes a case where the voltage regulator 209 is realized by a three-terminal regulator (linear voltage regulator). The second capacitor C2 may be connected between the input terminal (VIN) of the three-terminal regulator and the ground terminal (GND) of the three-terminal regulator. Between the output terminal (VOUT) of the three-terminal regulator and the ground terminal (GND) of the three-terminal regulator, a bypass capacitor Cout may be connected. The ground terminal (GND) of the three-terminal regulator may be connected to the ground terminal GND of the low-voltage device (the real-time clock or the controller 202) which receives the second battery power (BATT#2) from the output terminal (VOUT).

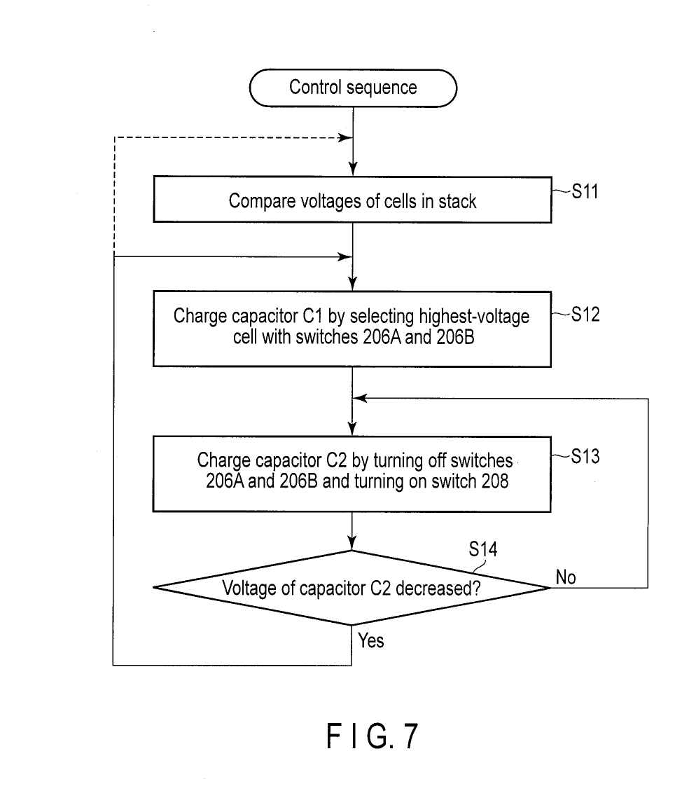

Next, this specification explains steps of the operation for generating the second battery power (BATT#2), referring to the flowchart of FIG. 7.

The controller 202 may determine the highest-voltage battery cell in the battery stack 201 by comparing the voltages of the battery cells in the battery stack 201 (step S11). The first switch 206 (interlock switches 206A and 206B) may select the highest-voltage battery cell under the control of the controller 202 (step S12). In step S12, the first switch 206 (interlock switches 206A and 206B) may be turned on in a state in which the second switch 208 is turned off. The highest-voltage battery cell may be connected to the first capacitor 01 by the first switch 206 (interlock switches 206A and 206B). By this structure, the first capacitor C1 is charged with the charge from the highest-voltage battery cell.

After this, under the control of the controller 202, the first switch 206 (interlock switches 206A and 206B) may be turned off and the second switch 208 may be turned on (step S13). By this operation, the second capacitor C2 is charged with the charge of the first capacitor C1. By using the charge of the second capacitor C2, the second battery power (BATT#2) is generated.

When the voltage of the second capacitor C2 is reduced to a reference voltage (YES in step S14), the processes of steps S12 and S13 may be executed again. In the case where the voltage of the second capacitor C2 is decreased to a reference voltage (YES in step S14), the process for determining the highest-voltage battery cell in the battery stack 201 may be conducted again in step S11. In this case, if the voltage of the selected battery cell is decreased, and the battery cell which had the second-highest voltage is the new highest-voltage battery cell, the new highest-voltage battery cell is selected by the first switch 206 (interlock switches 206A and 206B).

As described above, in the battery 20, the highest-voltage battery cell in the battery stack 201 is selected, and the second battery power (BATT#2) is supplied to a low-voltage device by using the charge from the selected battery cell.

In sum, the power of the battery 20 can be efficiently utilized compared to the case where the power which is obtained by stepping-down the high output voltage of the battery stack 201 is supplied to a low-voltage device.

The number of battery cells connected in series is not limited to two or three. Four or more than four battery cells may be connected in series. Further, a plurality of series battery cell groups each of which includes a plurality of battery cells connected in series may be connected in parallel.

The negative electrode of battery cell #1 in the battery stack 201 is not floating, and is connected to the ground terminal. Therefore, when battery cell #1 is selected, there is no need to prevent the negative electrode of the selected battery cell from being connected to the ground terminal of the real-time clock or the ground terminal of the controller 202. When battery cell #1 is selected, the second switch 208 may be turned on constantly.

The second battery power (BATT#2) may be supplied to a low-voltage device at any time regardless of the current state of the battery 20. The current state of the battery 20 may be a full-charge state, a charge-in-progress state, a discharge-in-progress state or a state which is close to over-discharge (a state in which the over-current protection switch 302 is turned off), etc.

The cell voltage of each battery cell in the battery stack 201 may be constantly or regularly measured. In this manner, the battery cell to be selected can be more dynamically changed.

Alternatively, the selected battery cell may be continuously used for the supply of the second battery power (BATT#2) until the voltage of the selected battery cell is reduced to a reference value. In this case, when the voltage of the selected battery cell is decreased to the reference value, the highest-voltage battery cell is selected from the remaining battery cells (the battery cell group having a voltage higher than the reference value).

In the above descriptions, this specification explains the structural example in which a voltage detector is connected to both ends of each battery cell. However, for example, one voltage detector may be connected to the subsequent stage of the first switch 206 (the place of the first capacitor C1). In this case, the highest-voltage battery cell can be selected by temporarily selecting a battery cell in order by means of the first switch 206 and monitoring the output of the voltage detector (cell voltage).

In the above descriptions, this specification explains the real-time clock (RTC) as an example of the low-voltage device in the electronic device 10. However, the second battery power (BATT#2) may be supplied to both the real-time clock (RTC) and another low-voltage device in the electronic device 10.

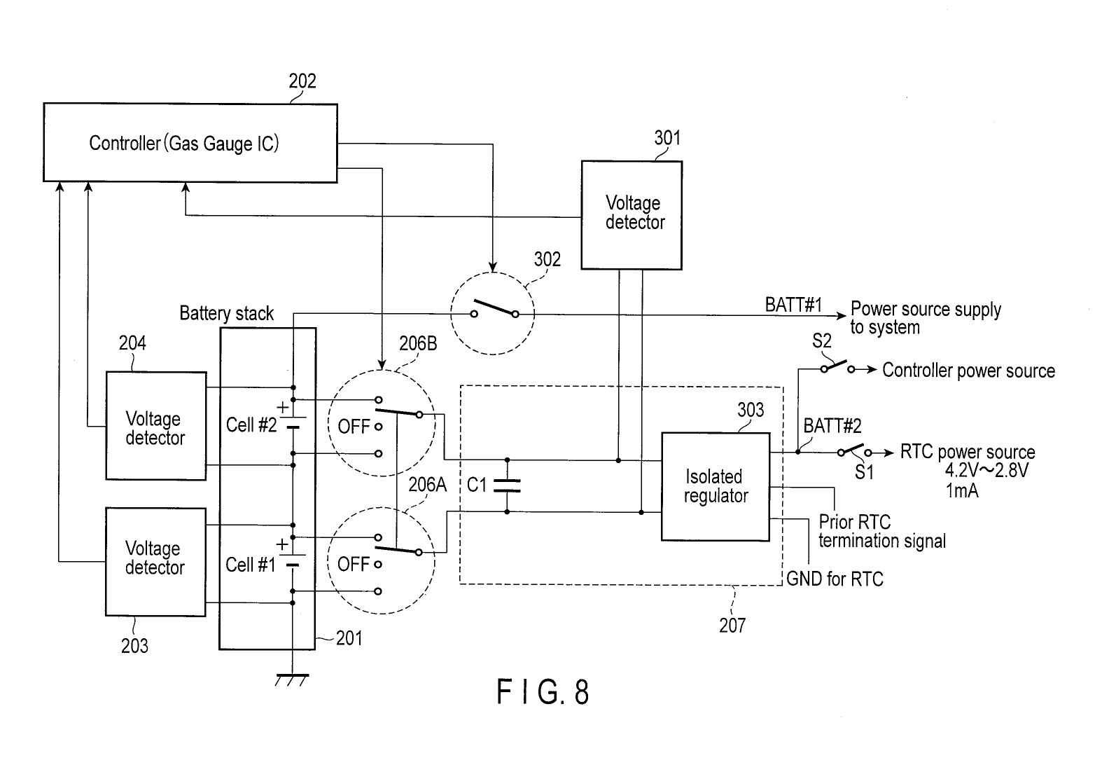

FIG. 8 illustrates another structure example of the battery 20.

Similarly to the structural example of FIG. 2, for simplification, FIG. 8 presumes a case where the battery stack 201 is composed of two battery cells #1 and #2 connected in series. In common with the structural example of FIG. 2, an over-current protection switch 302 is connected to the output of the battery stack 201. The feed circuit 207 may be composed of the first capacitor C1 and an isolated regulator 303. A step-down isolated regulator configured to decrease the input cell voltage may be employed for the isolated regulator 303. If the drive voltage of the controller 202 is higher than the cell voltage of one battery cell, the isolated regulator 303 may be a step-up isolated regulator configured to increase the input cell voltage.

The isolated regulator 303 converts the voltage of the first capacitor C1 into the voltage of the second battery power (BATT#2). As the isolated regulator 303, a voltage regulator including an isolation transformer such as an isolated flyback DC-DC converter can be used. In general, the size of the isolated regulator 303 is larger than the size of a voltage regulator such as a linear regulator. However, in the case where the isolated regulator 303 is used, since the primary side and the secondary side of the isolated regulator 303 are electrically isolated, the second switch 208 and the second capacitor C2 in FIG. 2 can be omitted.

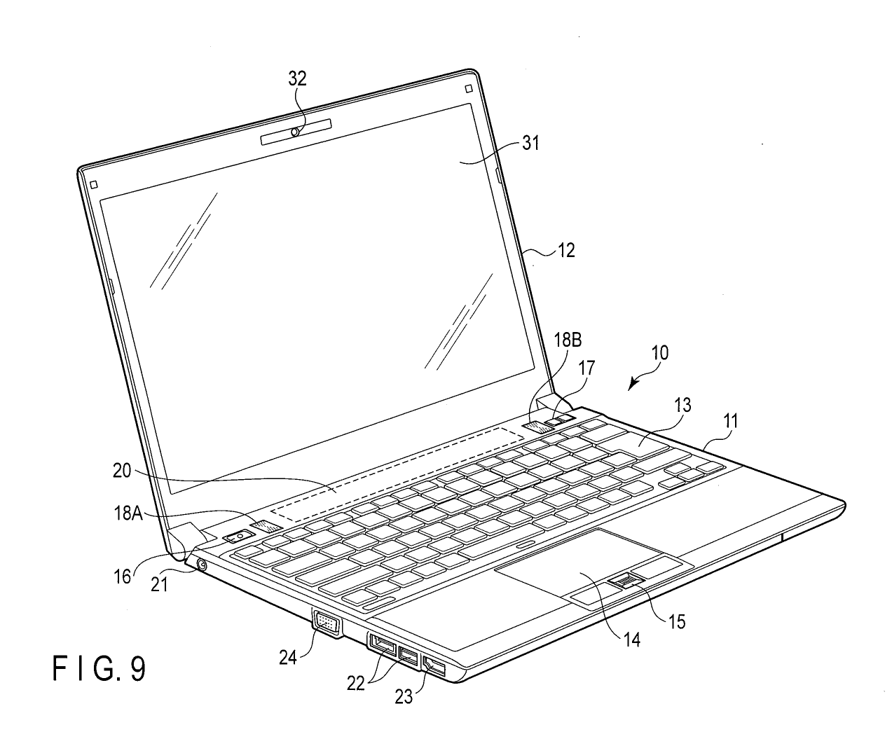

FIG. 9 illustrates the external appearance of the electronic device 10 in which the battery 20 is embedded.

The electronic device 10 can be realized as, for example, a notebook type of portable personal computer, a tablet terminal or other various portable electronic devices. Hereinafter, this specification presumes a case where the electronic device is realized as a notebook type of portable personal computer.

FIG. 9 is a perspective view when the electronic device (computer) 10 is viewed from the front side in a state in which a display unit is open. The electronic device 10 is configured to receive power from the battery 20. The electronic device 10 is configured to supply power (operating power) to the components of the electronic device 10 by using the power from the battery 20 or the power from an external power source device (AC adapter).

The electronic device 10 comprises a main body 11 and a display unit 12. The display unit 12 incorporates a display device such as a liquid crystal display device (LCD) 31. In the upper end portion of the display unit 12, a camera (webcam) 32 is provided.

The display unit 12 is attached to the main body 11 in order to be freely rotatable between the open position in which the upper surface of the main body 11 is exposed and the closed position in which the upper surface of the main body 11 is covered with the display unit 12. The main body 11 comprises a housing having a thin, box-like shape. A keyboard 13, a touchpad 14, a fingerprint sensor 15, a power switch 16 for turning on/off the electronic device 10, some feature buttons 17 and speakers 18A and 18B are provided on the upper surface of the housing.

A power source connector (DC power source input terminal) 21 is provided in the main body 11. The power source connector 21 is provided on a side surface of the main body 11, for example, the left side surface. An AC adaptor 150 is connected to the power source connector 21.

The battery 20 is, for example, embedded in the main body 11. The electronic device 10 is driven by the power from the AC adaptor 150 or the power from the battery 20. When the AC adapter 150 is connected to the power source connector 21 through a power source cable, the electronic device 10 is driven by the power from the AC adaptor 150. The power from the AC adaptor 150 is also used for charging the battery 20. While the AC adaptor 150 is not connected to the electronic device 10, the electronic device 10 is driven by the power from the battery 20.

Further, some USB ports 22, a high-definition multimedia interface (HDMI) output terminal 23 and an RGB port 24 are provided in the main body 11.

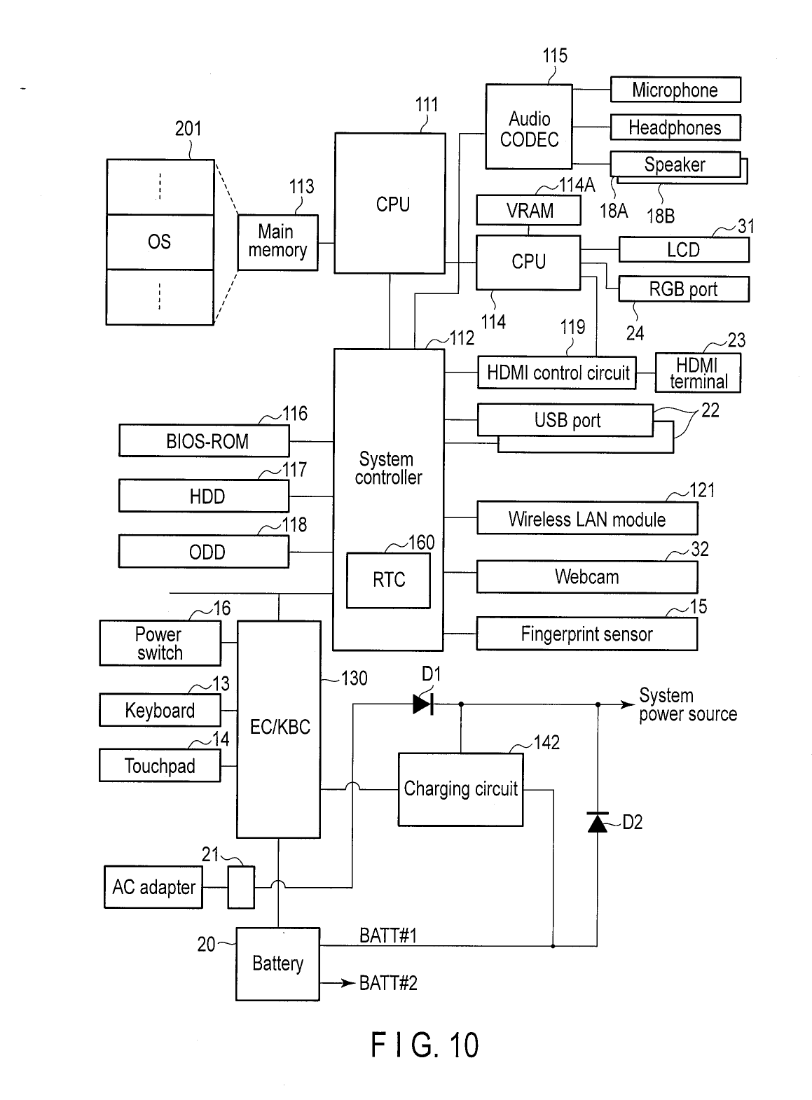

FIG. 10 illustrates the system configuration of the electronic device 10. The electronic device 10 comprises a CPU 111, a system controller 112, a main memory 113, a graphics processing unit (GPU) 114, an audio codec 115, a BIOS-ROM 116, a hard disk drive (HDD) 117, an optical disc drive (ODD) 118, a Bluetooth (registered trademark) (BT) module 120, a wireless LAN module 121 and an embedded controller/keyboard controller IC (EC/KBC) 130, etc.

The CPU 111 is a processor configured to control the operation of each component of the electronic device 10. The CPU 111 executes various programs loaded from the HDD 117 to the main memory 113. The programs include the operating system (OS) 201 and various application programs.

The CPU 111 also executes a Basic Input/Output System (BIOS) stored in the BIOS-ROM 116 which is a nonvolatile memory. The BIOS is a system program for hardware control.

The GPU 114 is a display controller configured to control the LCD 31 used as the display monitor of the electronic device 10. The GPU 114 generates a display signal (LVDS signal) to be supplied to the LCD 31 from the display data stored in a video memory (VRAM) 114A. The GPU 114 can also generate an analogue RGB signal and an HDMI video signal from the display data. The analogue RGB signal is supplied to an external display through the RGB port 24. The HDMI output terminal 23 can transmit the HDMI video signal (uncompressed digital video signal) and a digital audio signal to an external display through one cable. An HDMI control circuit 119 is an interface for transmitting the HDMI video signal and the digital audio signal to an external display through the HDMI output terminal 23.

The system controller 112 is a bridge device connecting the CPU 111 and each component. A serial ATA controller for controlling the hard disk drive (HDD) 117 and the optical disc drive (ODD) 118 is embedded in the system controller 112. Devices such as the USB ports 22, the wireless LAN module 121, the webcam 32 and the fingerprint sensor 15 are connected to the system controller 112. The system controller 112 further includes a real-time clock (RTC) 160. The real-time clock (RTC) 160 functions as a clock module configured to keep the current time and date (year, month, day, hour, minute and second). When the operating system (OS) 201 is booted, the operating system (OS) 201 can obtain the current time and date from the real-time clock (RTC) 160. The real-time clock (RTC) 160 may comprise a memory for storing various types of setting information (CMOS memory).

The EC/KBC 130 is a power management controller for executing the power management of the electronic device 10 and is realized as a one-chip microcomputer housing a keyboard controller configured to control the keyboard (KB) 13 and the touchpad 14, etc. The EC/KBC 130 has a function for turning on and off the electronic device 10 in accordance with the operation of the power switch 16 by the user. The EC/KBC 130 can communicate with each of the above-described charging circuit 142 and the above-described battery 20.

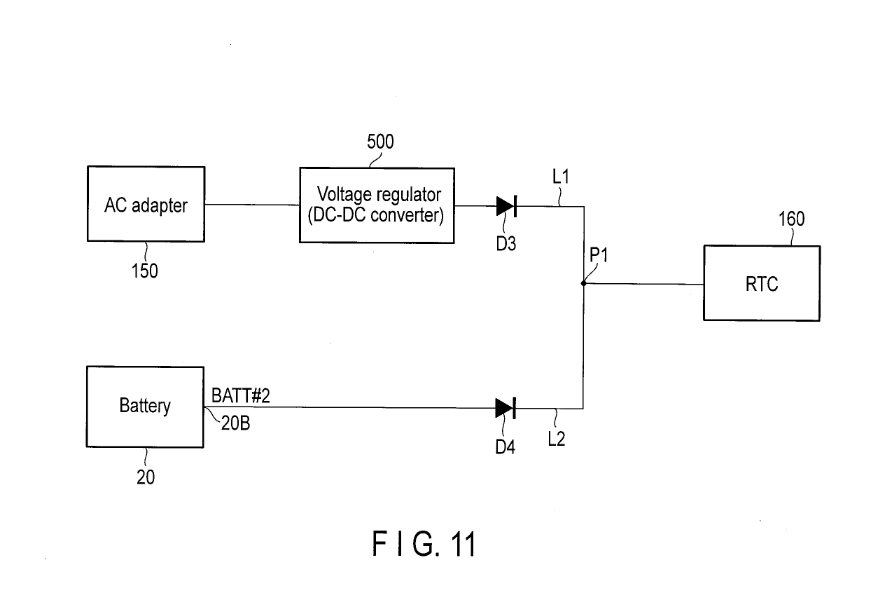

FIG. 11 illustrates a power source supply route to the real-time clock (RTC) 160.

The power source terminal (VCC) of the real-time clock (RTC) 160 is connected to an interconnection point P1 of a first power source supply line L1 and a second power source supply line L2. The first power source supply line L1 may be a system power source supply line for supplying power to the system. The output of the AC adapter 150 may be connected to the first power source supply line L1 via a voltage regulator (DC-DC converter) 500 and diode D3. A switch configured to be turned on or off by the power on/off signal from the EC/KBC 130 may be inserted into the first power source supply line L1.

The second power source supply line L2 is a power source supply line for supplying the second battery power (BATT#2) from the battery 20 to the real-time clock (RTC) 160. The second battery terminal 20B of the battery 20 may be connected to the second power source supply line L2 via diode D4. In other words, the second battery terminal 20B is connected to the interconnection point P1 via diode D4.

The voltage of the first power source supply line L1 may be set to be higher than the voltage of the second power source supply line L2. In this case, when the AC adapter 150 is connected to the electronic device 10, the voltage of the interconnection point P1 is higher than the voltage of the second battery terminal 20B of the battery 20. Therefore, the second battery power (BATT#2) is not supplied to the real-time clock (RTC) 160. Thus, the AC adapter 150 is used as the power source of the RTC 160 in preference to the second battery power (BATT#2).

On the other hand, when the AC adapter 150 is not connected to the electronic device 10, the second battery power (BATT#2) is used as the power source for supplying power to the real-time clock (RTC) 160. In other words, while the AC adapter 150 is not connected to the electronic device 10, the real-time clock (RTC) 160 is powered by the second battery power (BATT#2). Thus, the second battery power (BATT#2) can be used in place of the RTC battery. When the battery 20 is a built-in battery, power can be constantly supplied to the real-time clock (RTC) 160. In this manner, a system configuration which does not comprise an RTC battery can be realized.

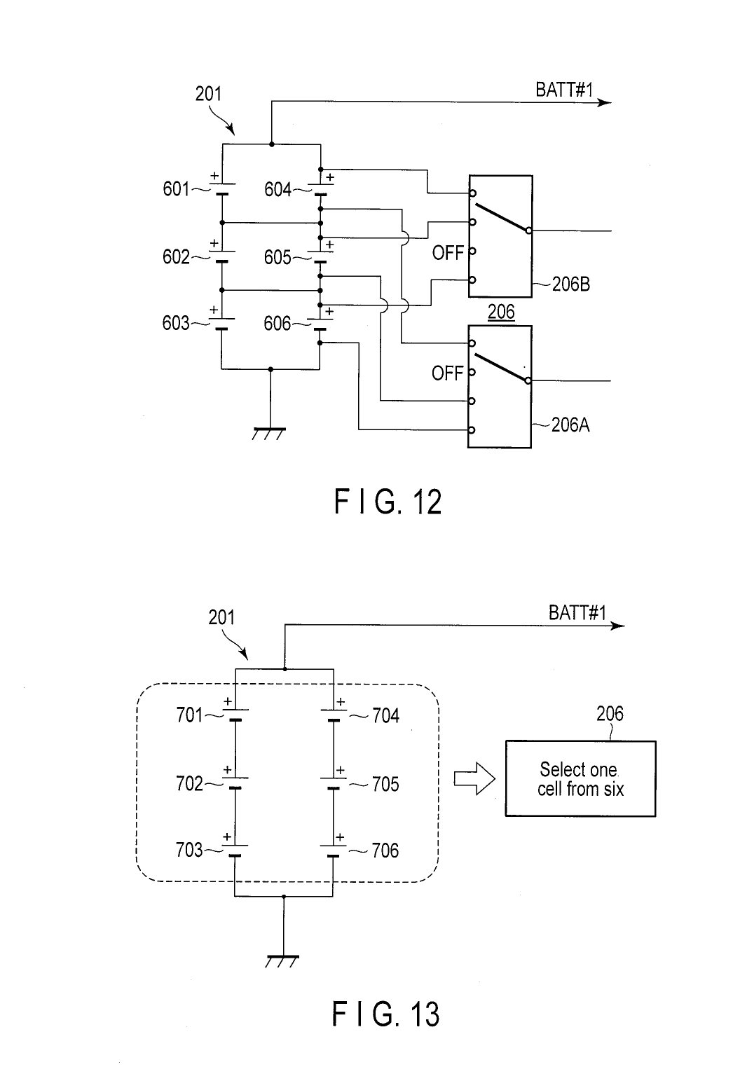

FIG. 12 illustrates another example of the structure of the battery stack 201.

The battery stack 201 of FIG. 12 has a three-serial/two-parallel stack structure. Specifically, the first series cell group includes three battery cells 601, 602 and 603 connected in series. The second series cell group includes three battery cells 604, 605 and 606 connected in series. Battery cell 601 and battery cell 604 are connected in parallel. Similarly, battery cell 602 and battery cell 605 are connected in parallel, and battery cell 603 and battery cell 606 are connected in parallel.

In this case, the first switch 206 (interlock switches 206A and 206B) may select the highest-voltage group from three groups connected in series (group 1: battery cells 601 and 604, group 2: battery cells 602 and 605, group 3: battery cells 603 and 606).

FIG. 13 illustrates another example of the structure of the battery stack 201.

The battery stack 201 of FIG. 13 has a three-serial/two-parallel stack structure. Specifically, the first series cell group includes three battery cells 701, 702 and 703 connected in series. The second series cell group includes three battery cells 704, 705 and 706 connected in series.

In this case, the first switch 206 may be configured to select the highest-voltage battery cell from six battery cells 701, 702, 703, 704, 705 and 706.

In the above explanations, this specification mainly describes the examples in the case where only the highest-voltage battery cell is selected from a plurality of battery cells connected in series. However, for example, in the case where the cell voltage of one battery cell is lower than the drive voltage of the target device, some adjacent battery cells (some battery cells connected in series) may be simultaneously selected from a plurality of battery cells connected in series.

For example, not only the highest-voltage battery cell, but also a battery cell adjacent to the highest-voltage battery cell may be simultaneously selected from a plurality of battery cells connected in series. In this case, the second power (second battery power) is obtained by using the charge of the highest-voltage battery cell and the charge of the adjacent battery cell. In this manner, even in the case where the cell voltage of one battery cell is low, the second power (second battery power) having the desired voltage can be supplied to a device.

As explained above, according to the embodiments described herein, the highest-voltage battery cell is selected from a plurality of battery cells connected in series. By using the charge of the selected battery cell, the second power (second battery power) is supplied to a device such as the real-time clock (RTC) 160. Therefore, the power of the battery 20 can be further efficiently used. Moreover, since the power discharged from the highest-voltage battery cell can be supplied to a device such as the real-time clock (RTC) 160, cell balancing can be efficiently performed.

As mentioned above, the number of battery cells selected from a plurality of battery cells connected in series is not limited to one. Two or more than two battery cells including the highest-voltage battery cell may be selected at a time.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery comprising:
a battery stack comprising a plurality of battery cells connected in series;
a controller configured to manage a state of the battery stack;
a first battery terminal electrically connected to a positive electrode of a topmost battery cell in the battery stack, wherein first power is supplied from the battery stack to a host through the first battery terminal;
a first switch configured to select a highest-voltage battery cell from the plurality of battery cells; and
a feed circuit configured to supply second power to a first device in the host through a second battery terminal of the battery or supply second power to the controller, by using a charge of the selected battery cell.

2. The battery of claim 1, wherein the feed circuit is configured to transfer the charge of the selected battery cell to the controller or the first device in a state in which a negative electrode of the selected battery cell is isolated from a ground terminal of the controller, or the negative electrode of the selected battery cell is isolated from a ground terminal of the first device.

3. The battery of claim 1, wherein the feed circuit comprises:
a first capacitor in a subsequent stage of the first switch;
a second capacitor;
a first circuit configured to supply the second power to the controller or the first device by using a charge of the second capacitor; and
a second switch connected between the first capacitor and the second capacitor, and
wherein the first capacitor is charged with the charge from the selected battery cell by turning on the first switch and turning off the second switch, and
the second capacitor is charged with a charge from the first capacitor by turning off the first switch and turning on the second switch.

4. The battery of claim 3, wherein the first circuit comprises a voltage regulator.

5. The battery of claim 1, wherein the first device is a real-time clock.

6. The battery of claim 1, further comprising a plurality of voltage detectors configured to measure voltages of the plurality of battery cells respectively.

7. The battery of claim 1, wherein the battery is a built-in battery embedded in the host.

8. An electronic device comprising:
a processor;
a real-time clock;
a battery stack comprising a plurality of battery cells connected in series;
a controller configured to manage a state of the battery stack;
a first battery terminal electrically connected to a positive electrode of a topmost battery cell in the battery stack, wherein first power is supplied from the battery stack to a load in the electronic device through the first battery terminal;
a first switch configured to select a highest-voltage battery cell from the plurality of battery cells; and
a feed circuit configured to supply second power to the controller or the real-time clock by using a charge of the selected battery cell.

9. The electronic device of claim 8, wherein the feed circuit is configured to transfer the charge of the selected battery cell to the controller or the real-time clock in a state in which a negative electrode of the selected battery cell is isolated from a ground terminal of the controller, or the negative electrode of the selected battery cell is isolated from a ground terminal of the real-time clock.

10. The electronic device of claim 8, wherein the feed circuit comprises:
a first capacitor in a subsequent stage of the first switch;
a second capacitor;
a first circuit configured to supply the second power to the controller or the real-time clock by using a charge of the second capacitor; and
a second switch connected between the first capacitor and the second capacitor, and
wherein the first capacitor is charged with the charge from the selected battery cell by turning on the first switch and turning off the second switch, and
the second capacitor is charged with a charge from the first capacitor by turning off the first switch and turning on the second switch.

11. The electronic device of claim 8, wherein the second power is supplied to the real-time clock.

12. The electronic device of claim 8, wherein the battery stack is included in a built-in battery embedded in the electronic device.

13. The electronic device of claim 8, wherein the battery stack, the controller, the first switch and the feed circuit are included in a built-in battery embedded in the electronic device.
